(19) United States
(12) Patent Application Publication
(10) Pub. No.: US 2014/0067742 A1
(43) Pub. Date: Mar. 6, 2014

(54) HYBRID INTERCONNECT STRATEGY FOR LARGE-SCALE NEURAL NETWORK SYSTEMS

(71) Applicant: International Business Machines Corporation, Armonk, NY (US)

(72) Inventors: Yasunao Katayama, Kawasaki (JP); Daiju Nakano, Kawasaki (JP); Toshiyuki Yamane, Kawasaki (JP)

(73) Assignee: International Business Machines Corporation, Armonk, NY (US)

(21) Appl. No.: 14/012,183

(22) Filed: Aug. 28, 2013

(30) Foreign Application Priority Data
Sep. 3, 2012 (JP) 2012-193327

(51) Int. Cl. G06N 3/04

(52) U.S. Cl. CPC G06N 3/04
USPC 706/29; 706/40; 706/27

(57) ABSTRACT

A plurality of chips arranged in a certain layout so as to face free space, and one or more optical elements are included. In the case where signal traffic for electrical communication with a given chip exceeds or is expected to exceed a certain threshold, a plurality of chips involved in communication routing of the excess signal traffic are identified, part of related signal traffic that crosses the plurality of identified chips is converted from an electric signal into an optical signal to re-route the excess signal traffic, and paths of the related signal traffic are dynamically adapted from fixed wired paths between the plurality of chips to optical communication paths formed in the free space.

### PRIORITY

This application claims priority to Japanese Patent Application No. 2012-193327, filed 3 Sep. 2012, and all the benefits accruing therefrom under 35 U.S.C. §119, the contents of which in its entirety are herein incorporated by reference.

### BACKGROUND

The present invention relates to configurations for realizing large-scale neural network systems. More specifically, the present invention relates to configurations for enabling hybrid interconnection of implementation by means of electronic circuits and implementation by means of optical systems in the case where processing elements equivalent to electrically imitated neurons are connected to each other.

Cognitive technology is attracting attention as a new computing paradigm. Also, research and development is being conducted on large-scale neural networks comparable to human brains. With the increasing scale of a network, the bandwidth (BW) of connection between neurons, for example, existing neuron connection methods using electrical packet switching, is becoming a bottleneck that restrains the overall performance of the network in terms of achieving performance higher than that of human brains.

The neural network implementations currently available are roughly classified into two types: implementation by means of electronic circuits, such as FPGA/ASIC (for example, Avinash Rajah, Mohamed Khalil Han, “ASIC DESIGN OF A KOHONEN NEURAL NETWORK MICROCHIP”, iICSE2004), and implementation by means of optical systems in which optical elements are used in combination (for example, U.S. Pat. No. 4,963,725 to John H. Hong et al.).

In implementation by means of electronic circuits, processing elements equivalent to neurons are integrated in a mesh-like pattern and are connected via fixed wiring. In this case, because a required strength of connection between each pair of processing elements differs depending on a learning algorithm, all potential connection paths need to be prepared beforehand using fixed wiring to allow for direct connection of processing elements.

However, in practice, the network architecture is prefixed when chips are fabricated with processing elements integrated. Also, the number of links (fanout) extending from one neuron is limited. Accordingly, communication between neurons that are not directly connected is performed via other neurons by using a time-division multiplexing communication scheme, such as packet communication.

As a result, in the case of a large number of neurons, collision and congestion occur because of the influence of signals hopping throughout the entire circuit. The collision and congestion are major causes of decrease in bandwidth and increase in latency. On the other hand, implementations by means of optical systems are constituted by combination of light emitters, optical elements such as lenses and mirrors, and logic elements such as threshold elements. However, it is difficult to integrate the entire optical system as densely as electronic circuits, and thus it is difficult to achieve a high performance by optical systems. Reconfigurable neuron connections whose architecture is flexibly changeable in accordance with a learning algorithm are also desired.

The neural network is a technology originally inspired by the nerve cell networks of brains. In a neural network, many neurons three-dimensionally connected via a large fanout form a layered structure. It is a major characteristic of a neural network that it changes the network architecture thereof and the weights of individual links thereof through learning.

Thus, allowing the network architecture to be flexibly reconfigurable in accordance with a result of learning (reconfigurability) is a major challenge in implementing a large-scale neural network, as well as allowing the neural network to operate with a practical circuit size at a practical processing speed even if the number of neurons increases (scalability).

Japanese Patent No. 4350373 and Japanese Patent No. 3262857 contain description about neural network devices but do not disclose the structure of a chip including an optical system.

Japanese Patent No. 3407266, Japanese Patent No. 2861784, and Japanese Patent No. 5-3078 contain description about optical neural chips but do not disclose any network reconfiguration method applied to an optical system portion.

### SUMMARY

In one embodiment, a network system includes a plurality of chips arranged in a certain layout to face free space, a plurality of certain chips among the plurality of chips being configured to be able to electrically communicate with each other via fixed wired paths; and one or more optical elements configured to convert an electric signal of a given chip among the plurality of chips into an optical signal and configured to enable optical communication to another chip via optical communication paths selected in the free space, direct communication from the given chip to the other chip not being electrically established via the fixed wired path; wherein in a case where signal traffic for electrical communication with a given chip exceeds or is expected to exceed a certain threshold, a plurality of chips involved in communication routing of the excess signal traffic are identified, part of related signal traffic that crosses the plurality of identified chips is converted from an electric signal into an optical signal, and the paths of the related signal traffic are dynamically and reconfigurably adapted from the fixed wired paths between the plurality of chips to optical communication paths formed by the one or more optical elements in the free space in order to re-route the excess signal traffic.

In another embodiment, a method is disclosed for causing a network system to operate, the network system including a plurality of chips arranged in a certain layout to face free space, a plurality of certain chips among the plurality of chips configured to be able to electrically communicate with each other via fixed wired paths, and one or more optical elements configured to convert an electric signal of a given chip among the plurality of chips into an optical signal and configured to enable optical communication to another chip via optical communication paths selected in the free space, direct communication from the given chip to the other chip not being electrically established via fixed wired paths. The method includes determining whether or not signal traffic for electrical communication with a given chip exceeds or is expected to exceed a certain threshold; identifying, in a case where the signal traffic exceeds or is expected to exceed the certain threshold, a plurality of chips involved in communication routing of the excess signal traffic; converting part of related signal traffic that crosses the plurality of identified chips from an electric signal into an optical signal; and dynamically and reconfigurably adapting the paths of the related signal traffic from fixed wired paths between the plurality of chips to optical communication paths formed by the one or more optical elements in the free space in order to re-route the excess signal traffic.

### BRIEF DESCRIPTION OF THE SEVERAL VIEWS OF THE DRAWINGS

FIG. 1 is a general view illustrating a configuration of a large-scale neural network system according to embodiments of the present invention that can flexibly reconfigure the network architecture thereof (or is reconfigurable) in accordance with a result of learning.

FIG. 2 is a diagram illustrating, as a configuration for realizing a large-scale neural network, an example of a hybrid architecture that combines implementation by means of electronic circuits such as chips in which processing elements equivalent to neurons are integrated and implementation by means of optical systems such as optical elements.

FIG. 3 is a diagram that describes disadvantages of implementation by means of electronic circuits in which electrical communication is performed using fixed wiring that forms a mesh network among a plurality of chips and implementation/performance advantages of implementation by means of optical systems in which optical communication is performed via optical communication paths selected in free space.

FIG. 4 is a schematic diagram that describes issues and meanings of imitating an architecture of biological neurons by using a hybrid architecture of a neural configuration by means of electronic circuits and a neural configuration by means of optical systems.

FIG. 5 is a diagram that describes comparison between an electrical neural cross-connection network and an optical neural connection network using free space.

FIG. 6 is a matrix diagram in which properties of brains, fixed wired cross-connections, and cross-connections using free space are compared.

FIG. 7 is a diagram that describes, from a more general viewpoint, meanings of interconnection where optical communication using free space according to the present invention is applied to a new computing paradigm that uses a neural network.

### DETAILED DESCRIPTION

Embodiments of the present invention provide a configuration of a large-scale neural network that can flexibly reconfigure the network architecture thereof (or is reconfigurable) in accordance with a result of learning.

There is disclosed a connection architecture of a large-scale high-performance neural network, which is constructed by combination of integration of electric-signal-based wired connections between neurons and flexibility of optical connections formed in free space and is capable of imitating brains with complicated three-dimensional connections.

As a result, a demand for large-scale neuron connections at human brain scale is met without compromising on the performance and integration. Also, a reconfigurable network that is flexibly changeable in accordance with a learning algorithm is provided.

A configuration for realizing a large-scale neural network uses combination of integration of electric-signal-based wired connections between neurons and flexibility of optical connections formed in free space to construct a large-scale high-performance neural network.

More specifically, a configuration is disclosed which includes a plurality of chips arranged in a certain layout to face free space, a plurality of certain chips among the plurality of chips configured to be able to electrically communicate with each other through fixed wired paths; and one or more optical elements configured to convert an electric signal of a given chip among the plurality of chips into an optical signal and configured to enable optical communication to another chip via an optical communication path selected in the free space, direct communication from the given chip to the other chip not being electrically established via fixed wired paths.

In this configuration, in the case where signal traffic for electrical communication on given chips exceeds or is expected to exceed a certain threshold and a plurality of chips involved in communication routing of the excess signal traffic are identified, part of related signal traffic that crosses the plurality of identified chips is converted from an electric signal into an optical signal, and the paths of the related signal traffic are dynamically and reconfigurably adapted from the fixed wired paths between the plurality of identified chips to optical communication paths formed by the one or more optical elements in the free space in order to re-route the excess signal traffic.

Configurations according to embodiments of the present invention provide at least the following unique advantages: First, the combination of use of fixed wired connections for electric signals and use of free space connections for optical signals can provide a connection architecture of a neural network that is, as an aggregation of artificial processing elements, capable of efficiently imitating brains with complicated three-dimensional connections. Second, a demand for complicated connections among many neurons can be met without decreasing the performance and integration. Third, a reconfigurable network that is flexibly changeable in accordance with a learning algorithm can be provided.

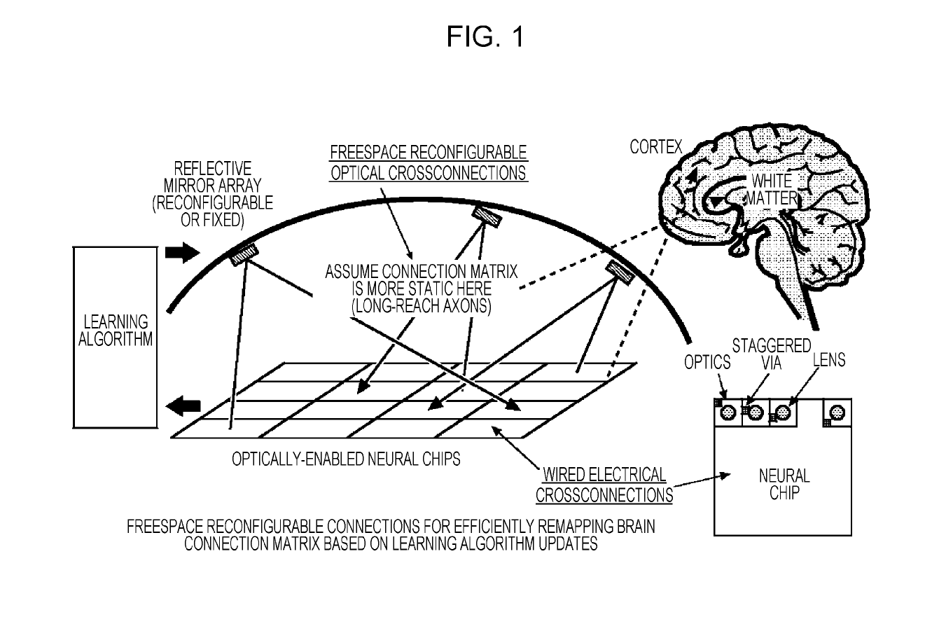

FIG. 1 is a general view illustrating a configuration of a large-scale neural network system according to embodiments of the present invention that can flexibly reconfigure the network architecture thereof (or is reconfigurable) in accordance with a result of learning.

The human brain is roughly classified into white matter and gray matter. The gray matter is a portion of the nervous tissue of the central nervous system where cell bodies of nerve cells are located. In contrast, a portion without cell bodies of nerve cells but having nerve fibers is called the white matter.

It is considered that the white matter has more myelinated nerve fibers than gray matter. Unlike the gray matter distributed as a thin cortex that covers surfaces of the cerebrum and cerebellum, the white matter is distributed by a relatively large amount in the diencephalon, brainstem, and spinal cord that are located close to the central part of the brains.

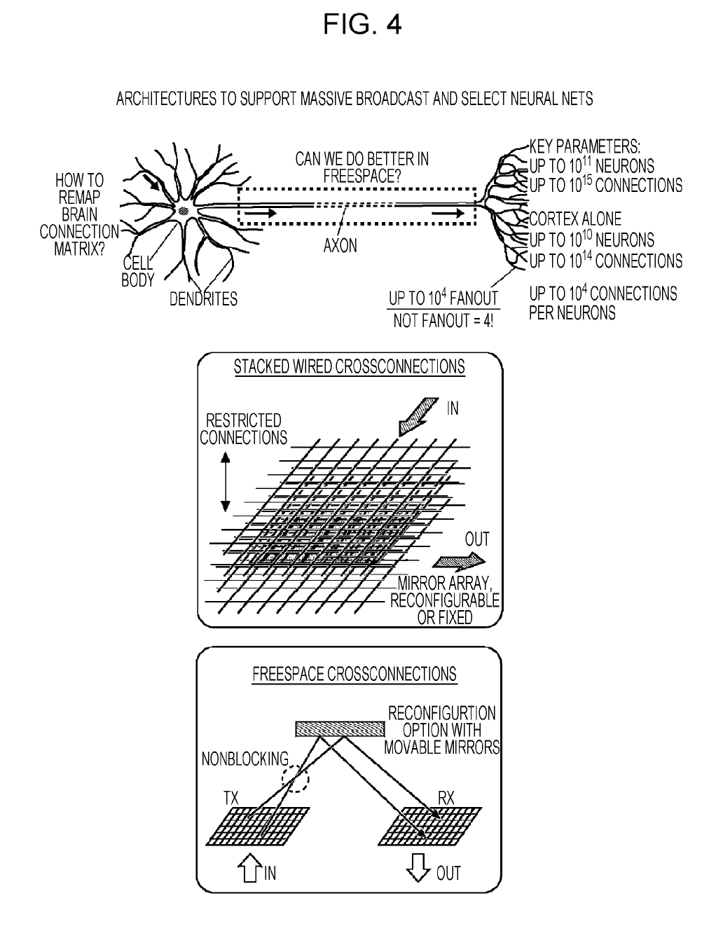

In the human brains, many neurons form a three-dimensional layered structure and communication paths, which can be realized in units of biological neurons (to be described later with reference to FIG. 4), are mapped complicatedly. Thus, it is not easy to imitate and organize such cross-connections by using artificial processing elements.

A network system according to the present invention includes a plurality of chips and one or more optical elements, and dynamically and reconfigurably adapts paths of signal traffic from fixed wired paths between the plurality of chips to optical communication paths formed by one or more optical elements in free space. Such a network, which is a large-scale neural network organized by imitating biological neurons, is flexibly adaptable to a change in the network architecture thereof. The plurality of chips are arranged in a certain layout to face free space. A plurality of certain chips among the plurality of chips are configured to be able to electrically communicate with each other via fixed wired paths.

FIG. 1 schematically illustrates the plurality of chips as a two-dimensional planar array but it is sufficient that the plurality of chips are arranged in a certain layout to face free space. For example, the plurality of chips may be arranged along a free-form surface.

Each optical element converts an electric signal of a given chip among the plurality of chips into an optical signal and enables optical communication to another chip via an optical communication path selected in free space, direct communication from the given chip to the other chip not being electrically established via the fixed wired paths.

FIG. 1 illustrates movable mirrors each capable of reflecting an optical signal converted from an electric signal of a given chip in an optical communication path and capable of changing a direction thereof so as to change a reflection direction.

When a plurality of (e.g., three in FIG. 1) mirrors are arranged in an array form so as to surround free space, the mirrors can advantageously provide many communication paths with individual groups of the plurality of chips for their exclusive use. However, even a single mirror can operate. As illustrated in a plan view, each of the chips may be a neural chip that includes optical elements (optics), via holes of a staggered pattern (staggered vias), and lenses. The chips enable hybrid interconnection of implementation by means of electronic circuits and implementation by means optical systems.

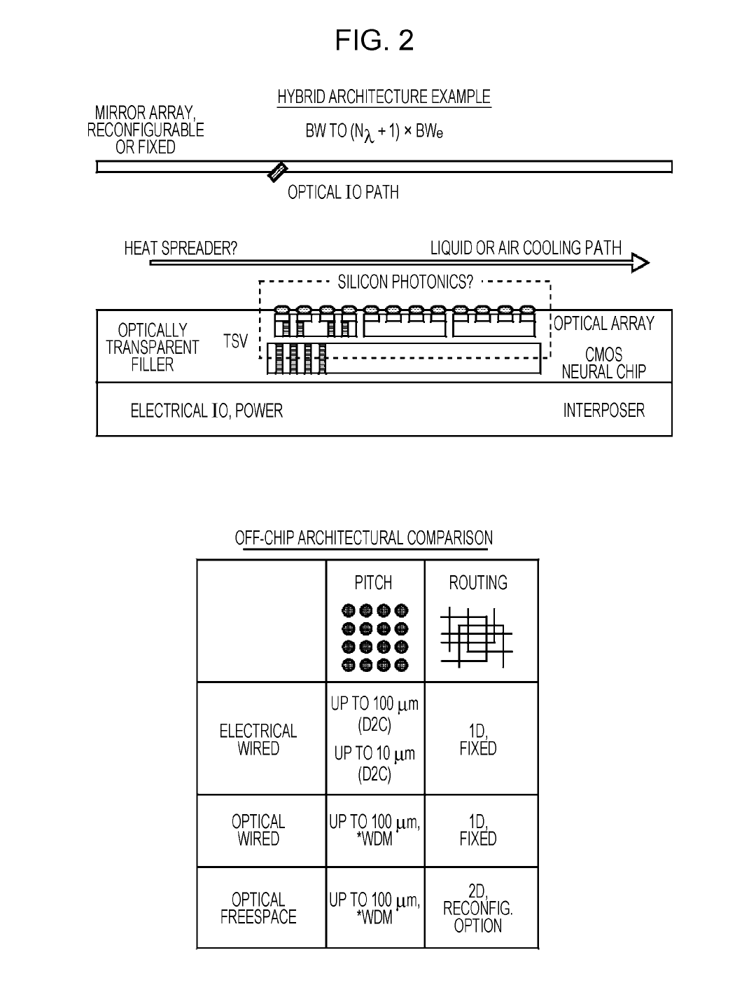

FIG. 2 is a diagram illustrating, as a configuration for realizing a large-scale neural network, an example of a hybrid architecture that combines implementation by means of electronic circuits such as chips in which processing elements equivalent to neurons are integrated and implementations by means of optical systems such as optical elements. The example illustrated in FIG. 2 is merely an example of a hybrid interconnection architecture employed in the case where implementation by means of electronic circuits such as chips and implementations by means of optical systems such as optical elements are used in combination with each other. In one embodiment, the neural chip may be a CMOS chip.

A plurality of electro-optical converters that perform conversion between an electric signal and an optical signal may be provided for the plurality of chips. This allows implementation by means of electronic circuits and implementation by means of optical systems to be integrated. A plurality of lenses may be provided. The plurality of electro-optical converters, the plurality of lenses, and the plurality of chips may be integrated using optically transparent filler resin (optically transparent filler).

FIG. 2 also illustrates a table that compares the estimated pitch value (pitch) and the dimension of routing among the cases of electrical wired connections (electrical wired), optical connections (optical wired), and optical connections using free space (optical free space). Because realization of hybrid interconnection requires realization of integration of implementation by means of electronic circuits and implementation by means of optical systems, these values and ranges thereof have important meanings.

WDM, which is an abbreviation of wavelength division multiplexing, overcomes the spatial limit regarding pitch by using the degree of freedom in the wavelength space in the case of implementation by means of optical systems, compared with implementations by means electronic circuits. For example, in a case where implementation by means of electronic circuits and implementation by means of optical systems have the same pitch, the use of WDM of N_{λ} wavelengths can increase the bandwidth substantially in proportion to the number of wavelengths N_{λ} because a relationship BWₒ˜(N_{λ}+1)×BWe holds and the bandwidth BW of connection between neurons is becoming a bottleneck that restrains the overall performance.

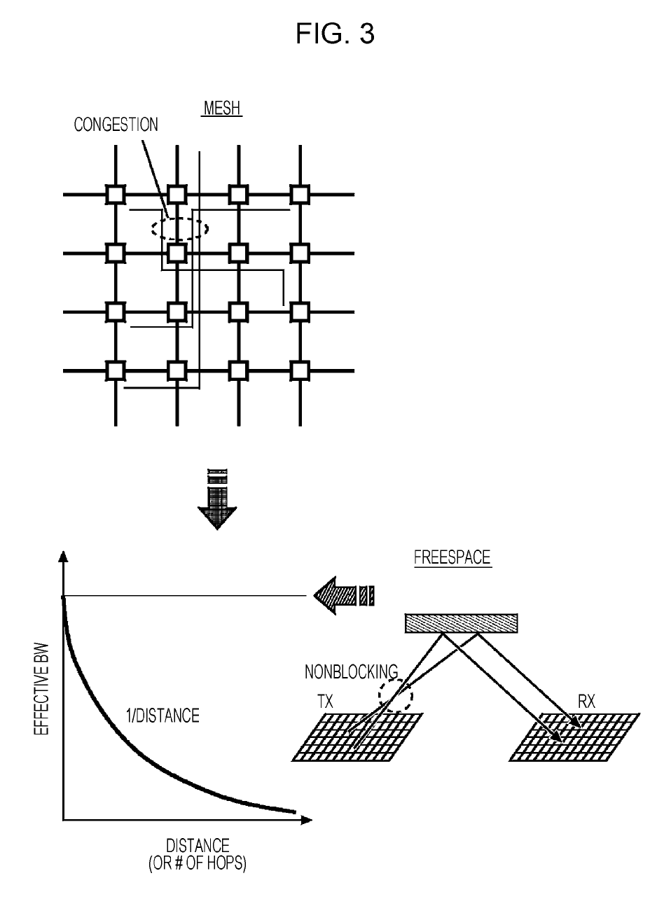

FIG. 3 is a diagram that describes disadvantages of implementation by means of electronic circuits in which electrical communication is performed via fixed wiring that forms a mesh network among the plurality of chips and advantages of implementation by means of optical systems in which optical communication is performed via optical communication paths selected in free space. The certain layout in which the plurality of chips is arranged in free space is illustrated as a two-dimensional array. Fixed wiring for electrical communication may form a mesh network among the plurality of chips. This corresponds to a simplified example of carrying out the present invention.

As a specific operation, it is determined whether or not signal traffic for specific electrical communication with a given chip exceeds or is expected to exceed a certain threshold. This can be done by actually monitoring signal traffic. However, in the case where such a circumstance is obviously expected to occur in response to specific processing, signal traffic needs not be monitored.

As illustrated in FIG. 3, collision of a plurality of signals causes congestion in communication routing. Because of this congestion, signal traffic for electronic communication with a given chip possibly exceeds a certain threshold. This is a major reason why the bandwidth of connection between neurons possibly becomes a bottleneck that restrains the overall performance. A bottleneck portion is not identified when a neural network system is created and sometimes remains unknown until processing is actually performed. In the case where signal traffic at a bottleneck portion exceeds or is expected to exceed the threshold, a plurality of chips involved in communication routing of the excess signal traffic are identified and part of related signal traffic that crosses the plurality of identified chips is converted from an electric signal into an optical signal.

The plurality of chips involved in communication routing of the excess signal traffic are often involved in a long routing path and it is expected that many chips instead of only two chips are involved over a wide range. The path of the related signal traffic is dynamically and reconfigurably adapted from the fixed wired paths between the plurality of chips to the optical communication paths formed by the one or more optical elements in free space in order to re-route the excess signal traffic. In this case, a routing distance (the number of hops) over the plurality of chips involved in the communication routing of the excess signal traffic should be taken into account. This is because, in the case of re-routing signal traffic with a larger routing distance (a larger number of hops between chips), the effective bandwidth (effective BW) can be improved by a larger amount as shown by the slope of the graph and the use of optical communication paths is more advantageous. In this way, a relationship between the identified chips and an amount of communication at which optical communication is increased is learned and stored in a storage device, and a large-scale neural network that is organized by imitating biological neurons can be flexibly reconfigured in accordance with an increase (or decrease) in fanout.

Reconfiguration can be performed so that both a bandwidth (BW) of the communication and a latency of the communication are optimized. Optical communication paths using free space permit independent optical signals to be transmitted without affecting each other even if the optical signals cross each other. Such a property is called nonblocking and is an ideal property for a cross-connection switch.

FIG. 4 is a schematic diagram that describes issues and meanings of imitating an architecture of biological neurons by a hybrid architecture of a neural configuration by means of electronic circuits and a neural configuration by means of optical systems. Biological neurons, which are also called nerve cells, are cells constituting the nervous system, have specialized functions for information processing and information transmission, and are unique to animals. A basic function of a nerve cell is to generate an action potential in response to input of stimulus thereto so as to transmit information to other cells. Stimulus is input to one nerve cell from a plurality of nerve cells or a threshold for generating the action potential is changed, whereby information is modified.

The nerve cell is roughly divided into three portions: a cell body (soma) including a nucleus, dendrites that receive input from other cells, and an axon that outputs information to other cells. The dendrites and axon follow substantially the same process during development and thus are sometimes collectively called neurites. A chemical substance transmission structure, called a synapse having a microscopic cleft, is provided at an information transmission portion between the axon terminal of a preceding cell and a dendrite of a following cell.

Regarding humans, the number of nerve cells increases in childhood as a result of active cell division and differentiation of neural stem cells. As differentiation of a nerve cell progresses, the nerve cell located at a specific position extends its axon to a specific cell in accordance with axon guidance to form a synapse, thereby forming a neural circuit. Various cortex portions in the brain include parts where various types of differentiation are seen for specific functions. For example, it is considered that the hippocampus has a nervous structure specialized in some kind of context processing. Many neurons three-dimensionally connected with a large fanout form a layered structure inside the brain. When this structure is imitated using a computer, the network architecture thereof and the weights of connections are changed through learning.

As a configuration for imitating the three-dimensional structure of brains, a stacked wired cross-connection structure (stacked wired cross-connections) may be formed by stacking many layers of fixed wiring. This structure, however, only provides restricted connections in the layered direction and thus has limitations.

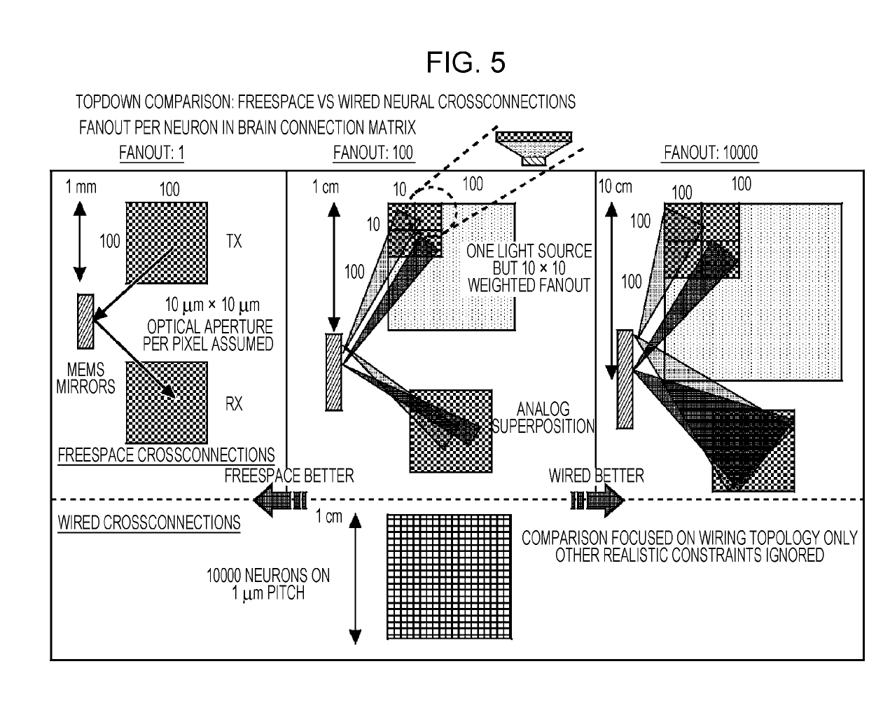

FIG. 5 is a diagram that describes comparison between an electrical neural cross-connection network and an optical neural connection network using free space. FIG. 5 illustrates a rough estimation of adaptation capabilities in accordance with the topology for the case where the fanout per neuron is increased. It is shown that as the fanout per neuron increases, an advantage is not necessarily obtained in terms of integration when transmissions are performed using free space optical communication.

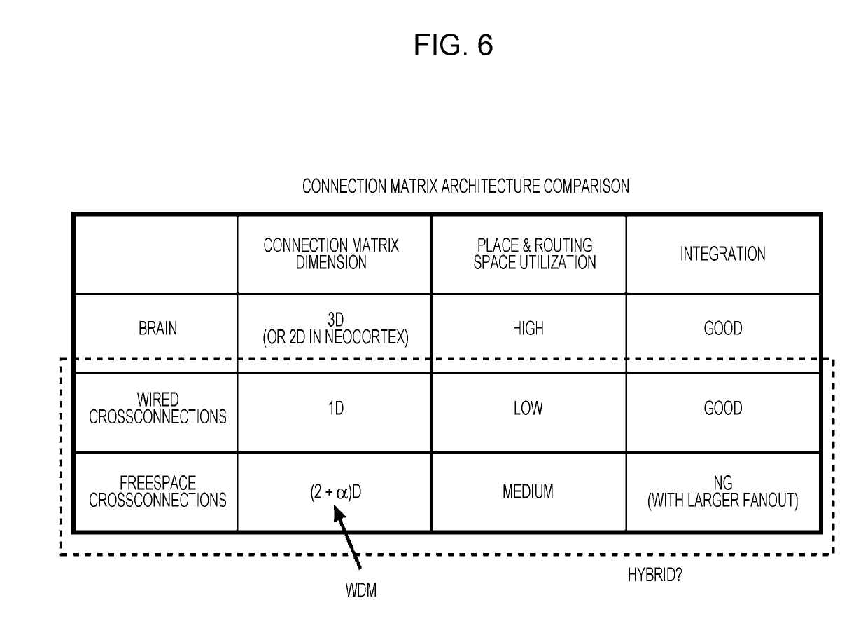

FIG. 6 is a matrix diagram in which properties of the brain, fixed wired cross-connections (wired cross-connections), and cross-connections using free space (free space cross-connections) are compared with each other. Comparison is made with regard to the connection matrix dimension, the place and routing space utilization, and the integration. In this comparison, the brain has excellent benchmark properties.

The fixed wired cross-connections have a low degree of freedom in terms of the place and routing space utilization and are not preferable for enabling flexible cross-connections. The cross-connections using free space are effective to bring the properties close to the excellent properties of brains but are unfavorable in terms of the integration as illustrated in FIG. 6. Accordingly, a hybrid configuration method is desired in which advantages of fixed wired cross-connections and of cross-connections using free space are used in combination with each other as disclosed by embodiments of the invention.

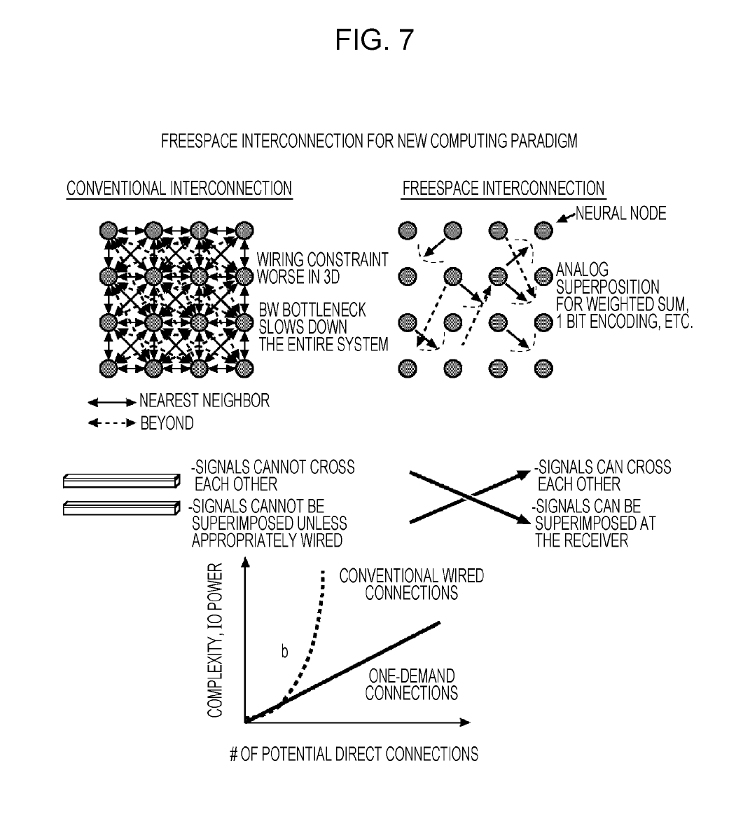

FIG. 7 is a diagram that describes, from a more general viewpoint, meanings of interconnection in the case where optical communication using free space according to the present invention is applied to a new computing paradigm that uses a neural network. Regarding conventional interconnection using fixed wiring, signals cannot cross each other unless the signals travel along different wired paths. Also, it is difficult to superpose different signals in an analog manner because of reflection of electric current. In contrast, regarding interconnection using free space, there is no restriction on crossing of signals in the free space and the influence of reflection of signal is limited. Thus, it is relatively easy to superpose signals in an analog manner in free space.

1. A network system, comprising:
a plurality of chips arranged in a certain layout to face free space, a plurality of certain chips among the plurality of chips being configured to be able to electrically communicate with each other via fixed wired paths; and
one or more optical elements configured to convert an electric signal of a given chip among the plurality of chips into an optical signal and configured to enable optical communication to another chip via optical communication paths selected in the free space, direct communication from the given chip to the other chip not being electrically established via the fixed wired path;
wherein in a case where signal traffic for electrical communication with a given chip exceeds or is expected to exceed a certain threshold, a plurality of chips involved in communication routing of the excess signal traffic are identified, part of related signal traffic that crosses the plurality of identified chips is converted from an electric signal into an optical signal, and the paths of the related signal traffic are dynamically and reconfigurably adapted from the fixed wired paths between the plurality of chips to optical communication paths formed by the one or more optical elements in the free space in order to re-route the excess signal traffic.

2. The network system according to claim 1, wherein the network system is a large-scale neural network organized by imitating biological neurons and is flexibly adaptable to a change in a network architecture thereof.

3. The network system according to claim 1, wherein:
the certain layout in which the plurality of chips are arranged in the free space is a two-dimensional array; and
the fixed wired paths form a mesh network among the plurality of chips.

4. The network system according to claim 1, wherein the one or more optical elements include a movable mirror capable of reflecting an optical signal converted from an electric signal of a given chip and capable of changing a direction thereof so as to change a reflection direction.

5. The network system according to claim 4, wherein the movable mirror includes a plurality of mirrors and the plurality of mirrors are arranged in an array form so as to surround the free space.

6. The network system according to claim 1, wherein:
a plurality of electro-optical converters configured to perform conversion between an electric signal and an optical signal and a plurality of lenses are provided for the plurality of chips; and
the plurality of electro-optical converters, the plurality of lenses, and the plurality of chips are integrated by optically transparent filler resin.

7. The network system according to claim 1, wherein a routing distance corresponding to the number of hops between chips over the plurality of chips involved in the communication routing of the excess signal traffic is taken into account in the dynamic and reconfigurable adaptation from fixed wired paths to optical communication paths formed by one or more optical elements in the free space.

8.-14. (canceled)
